(19) United States
(12) Patent Application Publication
(10) Pub. No.: US 2007/0154658 A1
(43) Pub. Date: Jul. 5, 2007

(54) LIQUID CRYSTAL ALIGNMENT AGENT

(75) Inventors: Jeong Hoon Kang, Kyeonggi-do (KR); Jae Min Oh, Suwon-si (KR); Wong Seok Dong, Kyeonggi-do (KR); Ji Young Jeong, Seoul-si (KR)

Correspondence Address: MYERS BIGEL SIBLEY & SAJOVEC, PO BOX 37428, RALEIGH, NC, 27627, US

(73) Assignee: Cheil Industries, Inc.

(21) Appl. No.: 11/559,021

(22) Filed: Nov. 13, 2006

(30) Foreign Application Priority Data
Dec. 30, 2005 (KR) 2005-135905

(51) Int. Cl. C09K 19/00

(52) U.S. Cl. 428/1.25

(57) ABSTRACT

Provided herein is a liquid crystal alignment agent including a polymer component including a polyamic acid repeating unit of Formula 1

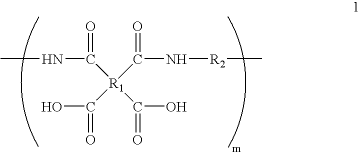

wherein
R₁ may be a tetravalent organic radical; and
R₂ may include a bivalent radical of Formula 2

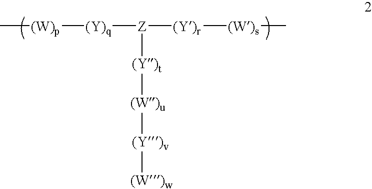

wherein one or more of the amic acids in one or more of the repeating units of Formula 1 may optionally be cyclized to form an imide.

Also provided herein is a liquid crystal alignment film and a liquid crystal display fabricated therefrom.

### CLAIM OF PRIORITY

This application claims priority under 35 U.S.C. §119 to Korean Application No. 2005-135905, filed on Dec. 30, 2005, the contents of which are herein incorporated by reference in their entirety.

### FIELD OF THE INVENTION

The present invention relates to liquid crystal alignment agents for use in liquid crystal displays (LCDs).

### BACKGROUND OF THE INVENTION

Currently available liquid crystal displays (LCDs) are generally fabricated by the following procedure. First, a liquid crystal alignment agent is applied to a pair of glass substrates onto which a transparent indium tin oxide (ITO) conductive film has been deposited. Then, the liquid crystal alignment agent is heat-cured to form an alignment film on each of the substrates. The substrates may then be faced toward and adhered to each other and a liquid crystal may be injected between the substrates. Alternatively, the substrates may be adhered to each other after a liquid crystal has been dropped onto one the substrates. Liquid crystal dropping processes may be employed in 5^{th} or higher generation medium- and large-sized LCD fabrication lines.

Solutions of polymer resins are commonly used as liquid crystal alignment agents that are applied to form alignment films. Polymer resins that have been used include polyamic acids, often polycondensation products of an aromatic acid dianhydride and an aromatic diamine; and polyimides, often prepared by the dehydration ring closure and imidization of the polyamic acids. The use of polyamic acids prepared from only aromatic acid dianhydrides and aromatic diamines is advantageous from the view point of heat stability, chemical resistance and mechanical properties, but the use of such polyamic acids may result in a deterioration in transparency and solubility due to the presence of a charge transfer complex and poor electrooptical properties.

Efforts to solve the above problems include, for example, Japanese Unexamined Patent Publication No. 11-84391, which describes the incorporation of an alicyclic acid dianhydride monomer or an alicyclic diamine; and Japanese Unexamined Patent Publication No. 06-136122, which describes the incorporation of a branched functional diamine, a branched functional acid dianhydride, or the like, to increase the pretilt angle and improve the stability. U.S. Pat. No. 5,420,233 further describes an alignment film that may be applied in a vertical alignment mode to constitute an LCD panel in which a liquid crystal is vertically aligned against the surface of a substrate. Since vertical alignment mode (VA-mode) is advantageous in terms of the high viewing angle and because it requires no alignment operation, e.g., rubbing, it may be suitable for the fabrication of large-sized displays. Many panel makers currently employ VA-mode for the fabrication of 40-inch or larger displays.

However, as the size of VA-type liquid crystal displays increases, many problems remain unsolved by conventional liquid crystal alignment agents. For example, polyamic acid alignment agents may undergo printing and curing at about 200° C. in LCD fabrication processes, but their imidization rate may be limited to about 20 to about 70% due to the fact that common polyamic acids only become completely imidized at a temperature of 300° C. or more. Therefore, relatively large amounts of carboxyl groups may be present on the surface of the alignment films and may adsorb to ionic impurities present within the liquid crystal. This may result in deterioration of the voltage holding ratio and may promote the formation of afterimages. In addition, polyimide alignment agents may also have an imidization rate of less than 100%, and so may also have the same deficiencies as polyamic alignment agents.

A functional branched diamine compound may also be incorporated into the main chain of the polymer to achieve vertical alignment of a liquid crystal. In this case, the hydrophobic side chains may lower the surface tension of the alignment film, so that a high pretilt angle of 80-89° may be achieved. However, due to the high flexibility of the long, e.g., C₆-C₂₄, alkyl groups that are often used as the side chains of the functional diamine, the pretilt angle may decrease when a physical impact occurs, such as that during liquid crystal dropping, which may leave spots on screens.

### SUMMARY OF THE INVENTION

In some embodiments of the present invention, provided is a liquid crystal alignment agent including

a polymer component including a polyamic acid repeating unit of Formula 1

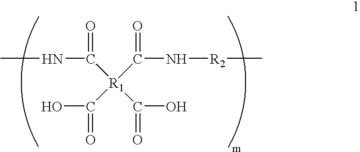

wherein
R₁ may be a tetravalent organic radical; and
R₂ may include a bivalent radical of Formula 2

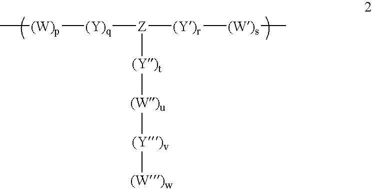

wherein

W, W′ and W″ may each independently be a bivalent aromatic, heteroaromatic, alicylic or heterocyclic radical, wherein the bivalent aromatic, heteroaromatic, alicyclic or heterocyclic radical is optionally substituted with an alkyl and/or a halogen group;

Y, Y′, Y″ and Y′″ may each independently be oxy, oxyacyl, acyloxy, acylamino, aminoacyl or alkylene;

Z may be a trivalent radical, such as a trivalent aromatic, heteroaromatic, alicyclic or heterocyclic radical, wherein the trivalent radical is optionally substituted with an alkyl group;

W′″ may be an aromatic, heteroaromatic, alicylic or heterocyclic radical, wherein the aromatic, heteroaromatic, alicyclic and heterocyclic radical may optionally be substituted with one or more linear, branched or cyclic alkyl radicals, and wherein the linear, branched or cyclic alkyl radicals may optionally be substituted with 1-10 halogen atoms and may optionally contain one or more of an ether, ester or amide linkage; and

wherein m is a positive integer;

wherein p, q, r, s, t, u, v and w may each independently be either 0 or 1, with the proviso that at least one of u and w must be 1;

wherein one or more of the amic acids in one or more of the repeating units of Formula 1 may optionally be cyclized to form an imide.

In some embodiments of the present invention, R₁ may be a tetravalent alicyclic radical, e.g., a tetravalent cyclobutane radical, a tetravalent cyclopentane radical, a tetravalent cyclohexane radical, a tetravalent cyclohexene radical, a tetravalent bicyclic alkane radical or a tetravalent bicyclic alkene radical. Furthermore, in some embodiments, the tetravalent alicyclic radical may optionally be substituted with one or more alkyl and/or fluoro groups.

In some embodiments, R₁ may be a tetravalent aromatic radical of the structure of Formula 3 or Formula 4

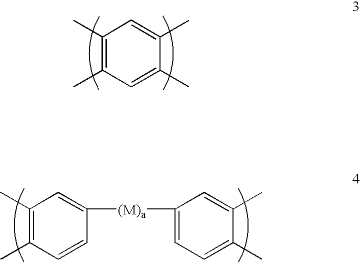

wherein M may be oxy, carbonyl, alkylene, or fluoralkylene; and a may either be 0 or 1.

In some embodiments, R₂ includes a bivalent radical of Formula 5

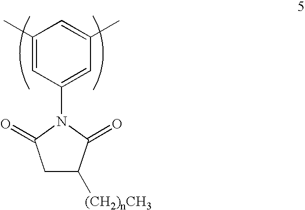

wherein n may be a positive integer in a range of about 1 to about 30.

In some embodiments, R₂ includes a bivalent radical of Formula 6

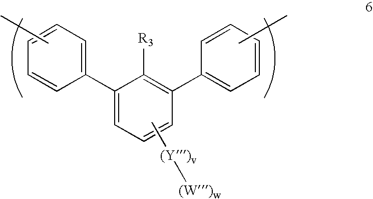

wherein

Y′″ may be oxy, acyloxy, oxyacyl, acylamino or C₁-C₁₀ alkylene;

W′″ may be a C₃-C₂₀ cyclic alkyl radical, wherein the cyclic alkyl may be optionally substituted with 1-10 halogen atoms and optionally may contain one or more of an ether, ester or amide linkage; a C₆-C₃₀ aryl radical, wherein the aryl radical may optionally be substituted with 1-10 halogen atoms and may optionally be substituted with one or more linear, branched or cyclic alkyl radicals, wherein the linear, branched or cyclic alkyl radicals may optionally contain one or more of an ether, ester or amide linkage; a C₆-C₃₀ heteroaryl radical; and

R₃ is hydrogen or a methyl group; and

v and w are 1.

In some embodiments of the present invention, R₂ includes a bivalent radical of Formula 7

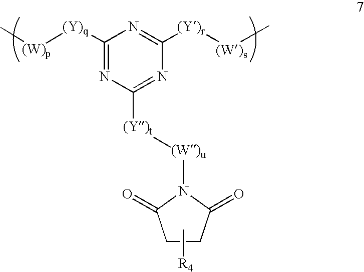

wherein

W and W′ may each independently be phenylene, alkyl-substituted phenylene or an alicyclic ring;

Y, Y′ and Y″ may each independently be oxy, acyloxy, oxyacyl or acylamino;

W″ may be phenylene or an alicyclic ring; and

R₄ may be a saturated or unsaturated C₁-C₂₀ linear, branched or cyclic alkyl group, wherein the alkyl group may optionally be substituted with at least one halogen atom.

In some embodiments of the present invention, R₂ includes a bivalent radical of Formula 8

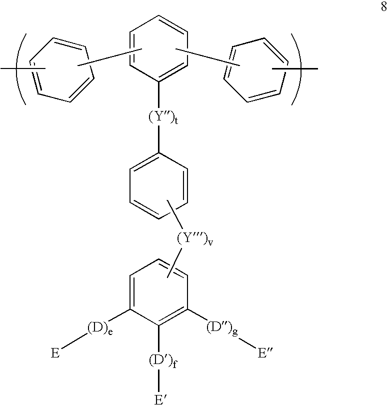

wherein

Y″ and Y′″ may each independently be oxy, acyloxy, oxyacyl or acylamino;

D, D′ and D″ may each independently be oxy, acyloxy, oxyacyl or acylamino, and e, f and g may each independently be 0 or 1; and

E, E′ and E″ may each independently be a C₁-C₂₀ linear, branched or cyclic alkyl group, optionally substituted with one or more halogen atoms.

Also provided herein is a liquid crystal alignment film produced by the application of a liquid crystal alignment agent according to an embodiment of the invention.

Furthermore, provided herein is a liquid crystal display fabricated with a liquid crystal alignment film according to an embodiment of the invention.

### BRIEF DESCRIPTION OF THE DRAWINGS

The above and other objects, features and other advantages of the present invention will be more clearly understood from the following detailed description taken in conjunction with the accompanying drawings, in which:

FIG. 1 shows the transmittance as a function of the applied voltage for the alignment films produced in Examples 1 to 5;

FIG. 2 shows the transmittance as a function of the applied voltage for the alignment films produced in Comparative Examples 1 to 5;

FIG. 3 shows the voltage holding ratio as a function of time for the alignment films produced in Examples 1 to 5;

FIG. 4 shows the voltage holding ratio as a function of time for the alignment films produced in Comparative Examples 1 to 5;

FIG. 5 is an FT-IR spectrum of the functional diamine prepared in Synthesis Example 1; and

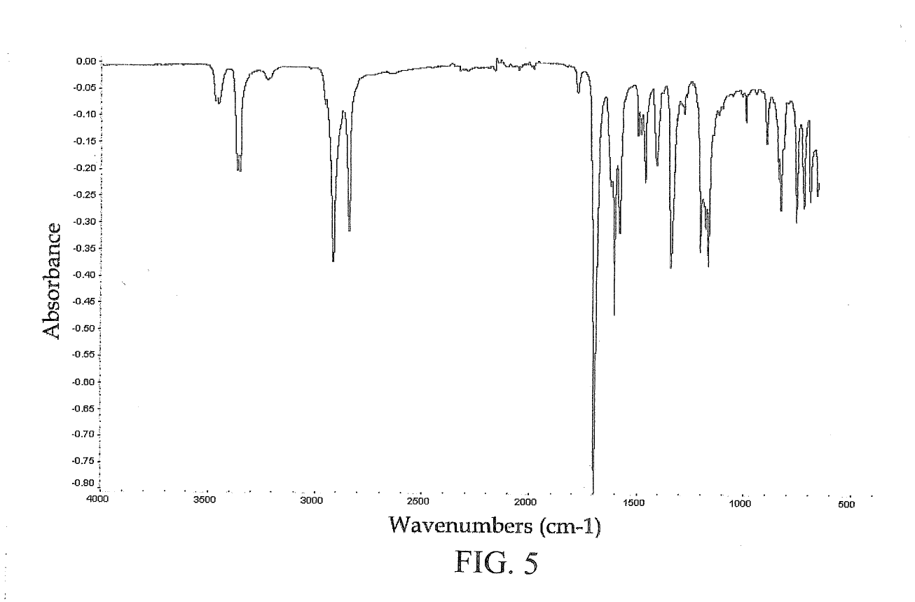

FIG. 6 is a ¹H-NMR spectrum of the functional diamine prepared in Synthesis Example 1.

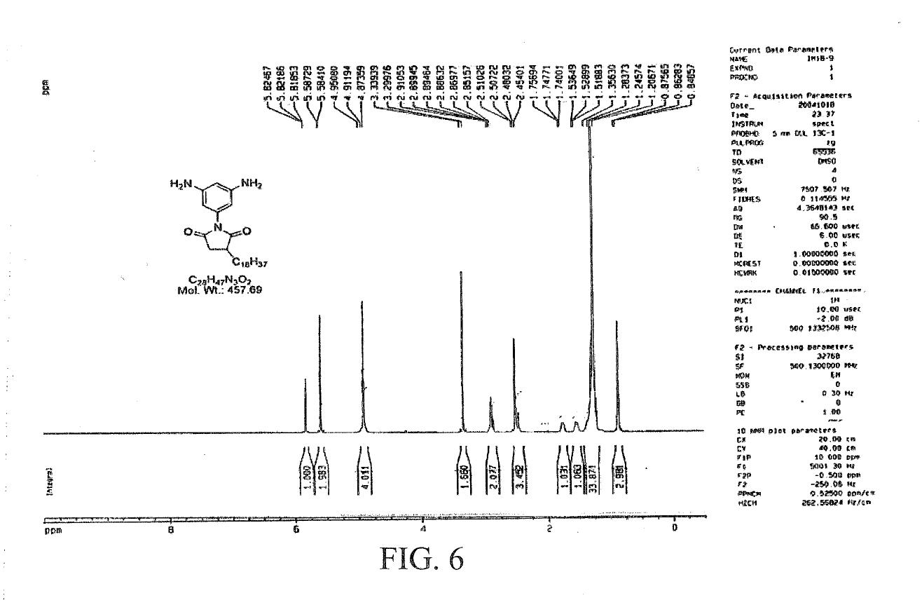

### DESCRIPTION OF THE PREFERRED EMBODIMENTS

The invention is described more fully hereinafter. This invention may, however, be embodied in many different forms and should not be construed as limited to the embodiments set forth herein. Rather, these embodiments are provided so that this disclosure will be thorough and complete, and will fully convey the scope of the invention to those skilled in the art.

It will be understood that when an element or layer is referred to as being “on,” another element or layer, it can be directly on, connected to, or coupled to the other element or layer, or intervening elements or layers may be present. In contrast, when an element is referred to as being “directly on,” “directly connected to,” or “directly coupled to” another element or layer, there are no intervening elements or layers present. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein,

The term “organic radical” refers to any suitable organic radical, such as, e.g., an aromatic, heteroaromatic, alicyclic, heterocyclic or aliphatic radical.

The term “sulfonyl” refers to a —SO₂— radical.

The terms “alkyl” and “alkylene” refer to a monovalent or bivalent (respectively) straight, branched, or cyclic hydrocarbon radical having from 1 to 30 carbon atoms. In some embodiments, the alkyl(ene) may be a “lower alkyl(ene)” wherein the alkyl(ene) group has 1 to 4 hydrocarbons. For example, lower alkyl may include methyl, ethyl, propyl, isopropyl, butyl, and iso-butyl, while lower alkylene may include methylene (—CH₂—), ethylene (—CH₂CH₂—), propylene (—CH₂CH₂CH₂—), isopropylene (—CH(CH₃)₂—), butylene (—CH₂CH₂CH₂CH₂—), iso-butylene (—C(CH₃)₂CH₂—) and the like. Another branched alkylene group is propane-2,2-diyl (—CH(CH₃)₂—). In some embodiments, the alkyl(ene) includes 1-10 carbon atoms. In some embodiments, the alkyl(ene) includes 1-20 carbon atoms. The alkyl(ene) may be unsubstituted or substituted with, e.g., a halogen atom. In some embodiments, the alkyl(ene) may contain one or more sites of unsaturation, and thus, when specified herein, the term alkyl(ene) may include an alkene or alkyne. Further, in some embodiments, the alkyl may contain one or more of an amide, ester or ether linkage within the alkyl chain. Thus, for example, when specified herein, the term alkyl(ene) may include such radicals as —CH₂CH₂—O—CH₂CH₃, —C(═O)NHCH₂CH₂CH₂—, —CH₂—O(C═O)CH₃, and the like. In addition, the term “one or more of an amide, ester or ether linkage” encompasses alkyl(ene) that include more than one kind of linkage. Thus, for example, an alkyl(ene) may include both an ether and an amide linkage.

The term “fluoroalkylene” refers to an alkylene, as defined above, wherein one or more of the hydrogen atoms is substituted with a fluoro group. The term “lower fluoroalkylene” refers to a “lower alkylene” group, as defined above, wherein one or more hydrogen atoms is substituted with a fluoro group. Exemplary lower fluoralkylene groups may include difluoromethylene and bis(trifluoromethyl)methylene (—CH(CF₃)₂—).

The term “oxy” refers to a —O— bivalent radical.

The term “aromatic radical” refers to any radical that includes a mono-, bi- or tricyclic aromatic group, including, e.g., the following tetravalent aromatic radicals:

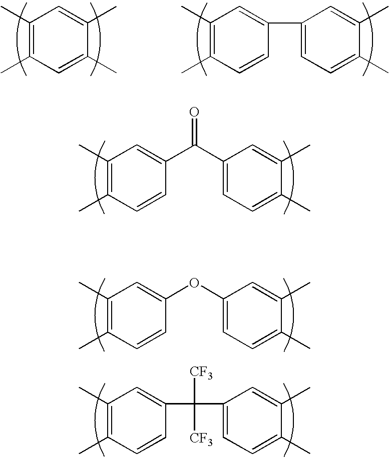

Examples of bivalent aromatic radicals (arylene) include phenylene, napthylidene, and the like. Examples of monovalent aromatic radicals (aryl) include phenyl and naphthyl. The aromatic radicals may be unsubstituted or substituted with, e.g., a halogen atom.

The term “heteroaromatic” refers to an aromatic radical, as defined herein, wherein one or more of the ring atoms is replaced with a heteroatom, e.g., O, N or S. Examples of heteroaromatic rings include furan, thiophene, pyrrole, and 1,3,5-triazine.

The terms “alicyclic ring” and “cyclic alkyl” refer to a carbocyclic ring structure, which may be saturated or unsaturated, but does not include aromatic compounds. The alicyclic ring may unsubstituted or substituted, e.g., with a halogen, carbonyl, hydroxy and the like. Examples of tetravalent alicyclic rings include the following chemical structures:

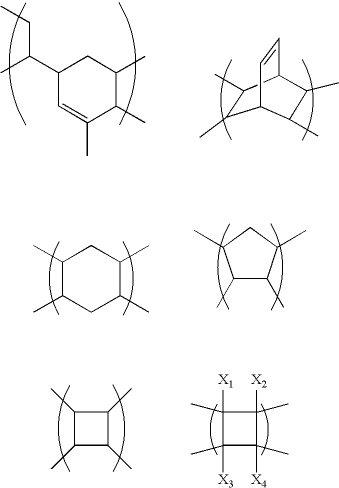

The term “heterocyclic ring” refers to an alicyclic ring, as described above, wherein one or more ring atoms is replaced with a heteroatom, e.g., O, N or S. Examples of heterocyclic rings include morpholine, 1,4-dioxane, piperidine and succinimide.

The term “alkylaryl” refers to an alkyl-substituted aryl radical. The term “arylalkyl” refers to an aryl-substituted alkyl radical.

The term “acyloxy” and “oxyacyl” refer to bivalent radicals of the structures —C(═O)O— and —OC(═O)—, respectively.

The terms “acylamino” and “aminoacyl” refer to a bivalent radical of the stricture —C(═O)NH— and —NHC(═O)—, respectively.

The term “halogen” refers to a F, Cl, Br or I radical.

The term “carbonyl” refers to a —C(═O)— bivalent radical.

The notation “Cₓ,” wherein x is an integer, will be used herein with reference to alkyl and aryl groups to denote an alkyl or aryl having x number of carbon atoms. Thus, for example, a C₅ alkyl refers to any alkyl having five carbon atoms, and a C₆-C₁₀ aryl refers to any aryl having from 6 to 10 carbon atoms.

As used herein, a subscript of a functional group set within parentheses, e.g., (G)ₓ, refers to the number of times the functional group occurs in the structure. Thus, when the subscript x is 0, the functional group is not present in the structure, and when the subscript is 1, the functional group is present in the chemical structure. If a subscript may be either 0 or 1, it is meant to refer to both embodiments where the functional group is present and embodiments where the functional group is not present.

When a subscript is 0 for a particular functional group, and thus the functional group is omitted from the structure, the resulting structure will be readily appreciable to one of skill in the art. For example, in the case where a functional group connects two other functional groups, the omission of the intermediate functional group results in the two other functional groups becoming directly bonded to one another. In the case where a first functional group is only bonded to one other functional group, the omission of the first functional group would result in a hydrogen radical added to other functional group in place of the first functional group. For example, in Formula 2, when Y′″ is methylene and w=0, the methylene group becomes a methyl group. As another example, in Formula 2, if u and w=1 and v=0, then W″ is directly bonded to W′″.

In some embodiments of the present invention, provided is a liquid crystal alignment agent including

a polymer component including a polyamic acid repeating unit of Formula 1

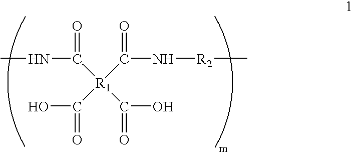

wherein
R₁ may be a tetravalent organic radical; and
R₂ may include a bivalent radical of Formula 2

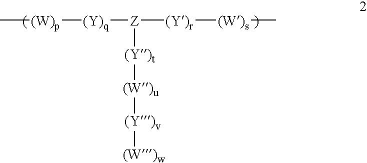

wherein

W, W′ and W″ may each independently be a bivalent aromatic, heteroaromatic, alicylic or heterocyclic radical, wherein the bivalent aromatic, heteroaromatic, alicyclic or heterocyclic radical may optionally be substituted with an alkyl and/or a halogen group;

Y, Y′ , Y″ and Y′″ may each independently be oxy, oxyacyl, acyloxy, acylamino, aminoacyl or alkylene;

Z may be a trivalent radical, such as a trivalent aromatic, heteroaromatic, alicyclic or heterocyclic radical, wherein the trivalent radical is optionally substituted with an alkyl group;

W′″ may be an aromatic, heteroaromatic, alicylic or heterocyclic radical, wherein the aromatic, heteroaromatic, alicyclic and heterocyclic radical may optionally be substituted with one or more linear, branched or cyclic alkyl radicals, and wherein said linear, branched or cyclic alkyl radicals may optionally be substituted with 1-10 halogen atoms, may optionally include one or more sites of unsaturation, and may optionally contain one or more of an ether, ester or amide linkage; and

wherein m is a positive integer;

wherein p, q, r, s, t, u, v and w may each independently be either 0 or 1, with the proviso that at least one of u and w must be 1;

wherein one or more of the amic acids in one or more of the repeating units of Formula 1 may optionally be cyclized to form an imide.

Thus, when the amic acids of the repeating unit are cyclized to form an imide, the following structure results:

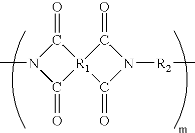

Thus, in some embodiments of the present invention, one or more of the amic acids of the repeating unit of Formula 1 are cyclized to form an imide. The polymer may be partially, substantially or wholly imidized. Furthermore, a mixture of polymers may be used wherein some of the polymer chains are not imidized, while other polymer chains are partially, substantially or wholly imidized.

In some embodiments of the present invention, R₁ may be a tetravalent alicyclic radical, e.g., a tetravalent cyclobutane radical, a tetravalent cyclopentane radical, a tetravalent cyclohexane radical, a tetravalent cyclohexene radical, a tetravalent bicyclic alkane radical or a tetravalent bicyclic alkene radical. Furthermore, in some embodiments, the tetravalent alicyclic radical may optionally be substituted with one or more alkyl and/or fluoro groups. For example, R₁ may be one of the following tetravalent alicyclic radicals:

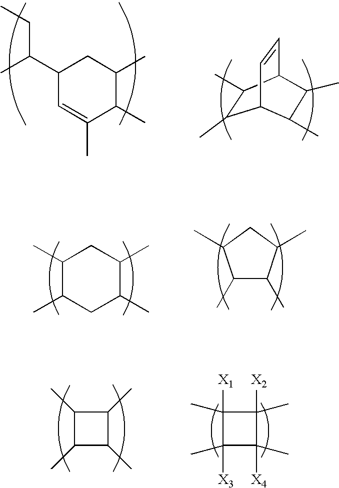

wherein X₁-X₄ are each independently methyl, F or H.

In some embodiments, R₁ may be a tetravalent aromatic radical of the structure of Formula 3 or Formula 4

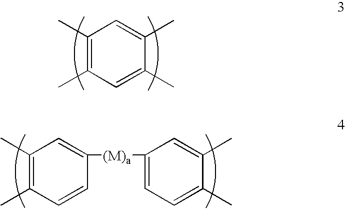

wherein M may be oxy, carbonyl, alkylene, or fluoralkylene; and a may be 0 or 1. For example, R₁ may be one of the following tetravalent aromatic radicals:

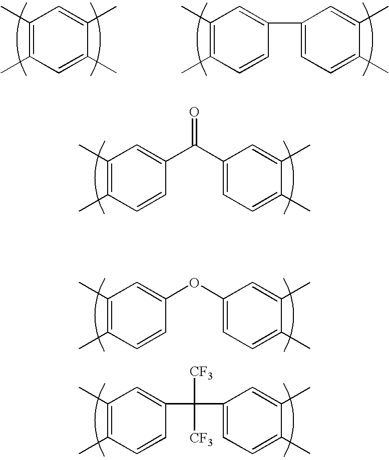

In some embodiments, R₂ includes a bivalent radical of Formula 5

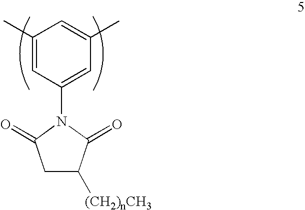

wherein n may be a positive integer in a range of about 1 to about 30.

In some embodiments, R₂ includes a bivalent radical of Formula 6

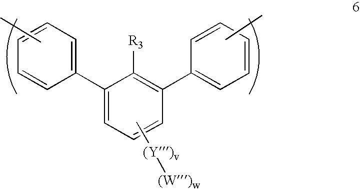

wherein

Y′″ may be oxy, acyloxy, oxyacyl, acylamino or C₁-C₁₀ alkylene;

W′″ may be a C₃-C₂₀ cyclic alkyl radical, wherein the cyclic alkyl may be optionally substituted with 1-10 halogen atoms and optionally may contain one or more of an ether, ester or amide linkage; a C₆-C₃₀ aryl radical, wherein the aryl radical may optionally be substituted with 1-10 halogen atoms and may optionally be substituted with one or more linear, branched or cyclic alkyl radicals, wherein the linear, branched or cyclic alkyl radicals may optionally contain one or more of an ether, ester or amide linkage; a C₆-C₃₀ heteroaryl radical;

R₃ is hydrogen or a methyl group; and

v an w are 1.

In some embodiments of the present invention, R₂ includes a bivalent radical of Formula 7

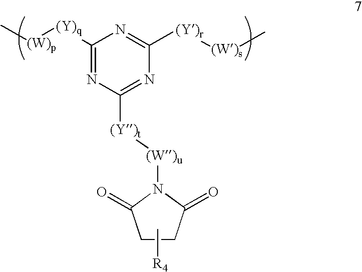

wherein

W and W′ may each independently be phenylene, alkyl-substituted phenylene or an alicyclic ring;

Y, Y′ and Y″ may each independently be oxy, acyloxy, oxyacyl or acylamino;

W″ may be phenylene or an alicyclic ring; and

R₄ may be a saturated or unsaturated C₁-C₂₀ linear, branched or cyclic alkyl group, wherein the alkyl group may optionally be substituted with at least one halogen atom.

In some embodiments of the present invention, R₂ includes a bivalent radical of Formula 8

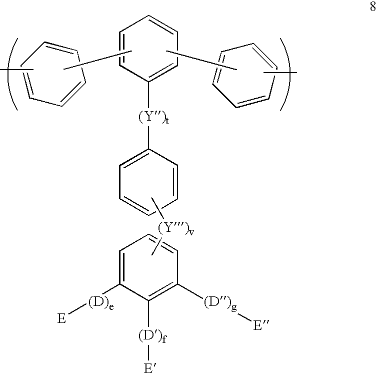

wherein

Y″ and Y′″ may each independently be oxy, acyloxy, oxyacyl or acylamino;

D, D′ and D″ may each independently be oxy, acyloxy, oxyacyl or acylamino, and e, f and g may each independently be 0 or 1; and

E, E′ and E ″ may each independently be a C₁-C₂₀ linear, branched or cyclic alkyl group, optionally substituted with one or more halogen atoms.

In some embodiments of the present invention, provided is a liquid crystal alignment agent including

a polymer component including a polyamic acid repeating unit of Formula 1

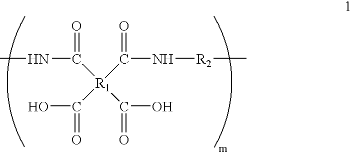

wherein

R₁ may be a tetravalent organic radical, as described above, and R₂ may includes a bivalent radical of Formula 6

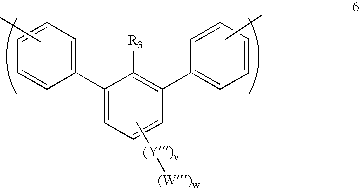

wherein

Y′″ may be oxy, acyloxy, oxyacyl, acylamino or C₁-C₁₀ alkylene;

W′″ may be a C₁-C₂₀ linear or branched alkyl radical, wherein the linear or branched alkyl radical may be optionally substituted with 1-10 halogen atoms and optionally may contain one or more of an ether, ester or amide linkage;

R₃ may be hydrogen or a methyl group; and

v and w may be 1.

In some embodiments of the present invention, R₂ may further include a bivalent siloxane of Formula 9 below:

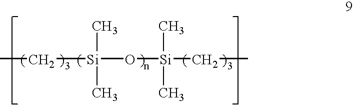

wherein n is an integer from 1 to 10.

In some embodiments of the present invention, R₂ may further include a bivalent aromatic radical. In some embodiments, the bivalent aromatic radical may include one or more of the structures of Formulae 10-12.

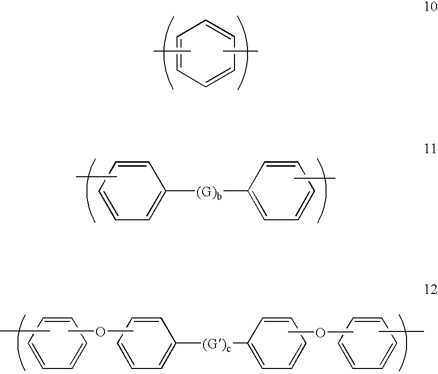

wherein

G and G′ may each independently be oxy, sulfonyl, linear or branched alkylene or linear or branched fluoroalkylene, and b anc c may be 0 or 1. In particular embodiments, G and G′ may be sulfonyl, methylene, oxy, bis(triflouromethyl)methylene or propane-2,2-diyl.

In some embodiments, the bivalent aromatic radical and bivalent siloxane radical may together be present in the polymer in an amount in a range of about 0.01 to about 99.9 mol %, based on the total mol of R₂ bivalent radicals. In some embodiments, the bivalent aromatic radical and the bivalent siloxane radical may be present in an amount in a range of about 70 to about 99.5 mol %, and in some embodiments, in an amount in a range of about 80 to about 99 mol %, based on the total moles of the R₂ bivalent radicals.

In some embodiments of the present invention, the liquid crystal alignment agent may further include an epoxy compound and/or an organic solvent.

The term “epoxy compound” refers to a compound that includes an epoxide group. In some embodiments, the epoxy compound has two to four epoxide groups per molecule. Examples of epoxy compounds having two epoxy groups include N,N-diglycidylaniline, N,N-diglycidyltoluidine, N,N-diglycidylcyclohexylamine, and N,N-diglycidylmethylcyclohexylamine. Epoxy compounds having four epoxy groups preferably have a structure wherein four glycidyl groups are linked to diamino phenyl, and specific examples thereof include N,N,N′,N′-tetraglycidyl-4,4′-diaminophenylmethane (TGDDM), N,N,N′,N′-tetraglycidyl-4,4′-diaminophenylethane, N,N,N′,N′-tetraglycidyl-4,4′-diaminophenylpropane, N,N,N′,N′-tetraglycidyl-4,4′-diaminophenylbutane, and N,N,N′,N′-tetraglycidyl-4,4′ -diaminobenzene.

In some embodiments, the epoxy compound may have the structure of Formula 6:

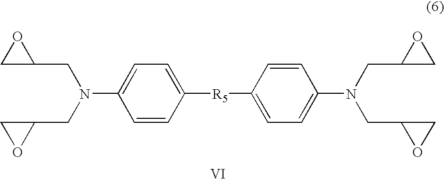

wherein R₅ is an aromatic or C₁-C₄ alicyclic bivalent organic group.

In some embodiments of the present invention, the epoxy compound is preferably present in the liquid crystal alignment agent in an amount in a range of about 0.01 to about 50 parts by weight, and in some embodiments, in a range of about 1 to about 30 parts by weight, based on 100 parts by weight of the polymer component. If the epoxy compound is used in an amount exceeding about 50 parts by weight, printability and flatness of the alignment agent may be deteriorated when the alignment agent is applied to a substrate. Meanwhile, if the epoxy compound is used in an amount of less than 0.01 parts by weight, the addition of the epoxy compound may have little or no effect.

The presence of the bivalent radical of Formula 2 in the polymer component may provide control over the pretilt angle of a liquid crystal and may allow for superior liquid crystal alignment. The pretilt angle may vary with the content of the bivalent radical of Formula 2, so that the bivalent radical of Formula 2 may be used alone without using the bivalent aromatic radical or the bivalent siloxane radical to prepare the polymer component, which is then applied to a substrate to produce a liquid crystal alignment film. Thus, the use of the bivalent aromatic radical and the bivalent siloxane radical is optional. In some embodiments of the present invention, the content of the bivalent radical of Formula 2 in the polymer component is in a range of about 0.1 to about 50 mol %, and preferably in a range of about 0.5 to about 30 mol %, and more preferably in a range of about 1 to about 20 mole %, based on the total amount of the R₂ bivalent radicals.

Any copolymerization method known in the art for preparing the polymer component may be employed, without any particular limitation. In some embodiments, the polymer component is synthesized by the reaction of an acid dianhydride and a diamine.

Suitable aromatic diamines that may be used to incorporate a bivalent aromatic radical into the polymer component are diamines of the organic groups represented by Formulae 10-12, and examples thereof include, but are not limited to, paraphenylenediamine (p-PDA), 4,4-methylenedianiline (MDA), 4,4-oxydianiline (ODA), meta-bisaminophenoxydiphenylsulfone (m-BAPS), parabisaminophenoxydiphenylsulfone (p-BAPS), 2,2-bisaminophenoxyphenylpropane (BAPP) and 2,2-bisaminophenoxyphenylhexafluoropropane (HF-BAPP).

The use of an aromatic acid dianhydride used in the preparation of the polymer component may allow for an alignment agent that produces an alignment film having a thickness of about 0.1 μm, which is resistant to rubbing processes employed to induce unidirectional alignment of a liquid crystal, is highly heat-resistant to high-temperature processing at 200° C. or above and exhibits superior chemical resistance.

In some embodiments, the aromatic dianhydrides may incorporate the structures of Formulae 3 and 4. Examples of such aromatic acid dianhydrides include, but are not limited to pyromellitic dianhydride (PMDA), biphthalic dianhydride (BPDA), oxydiphthalic dianhydride (ODPA), benzophenonetetracarboxylic dianhydride (BTDA) and hexafluoroisopropylidenediphthalic dialhiydride (6-FDA).

In some embodiments of the present invention, an aromatic acid dianhydride may be present in an amount in a range of about 10 to about 95 mol %, and preferably in an amount in a range of about 50 to about 90 mol %, based on the total amount of the acid dianhydrides used. When the content of the aromatic acid dianhydride is less than 10 mol %, the mechanical properties and heat resistance of the final alignment film may be poor. Meanwhile, when the content of the cyclic aromatic acid dianhydride is greater than 80 mol %, the electrical properties, such as voltage holding ratio, of the alignment film may be deteriorated.

The use of an alicyclic acid dianhydride in the preparation of the polymer component in the present invention may ameliorate various problems, e.g., insolubility in common organic solvents, low transmittance in the visible wavelength range due to the presence of a charge transfer complex and poor electrooptical properties due to high polarity resulting from the molecular structure.

In some embodiments, an alicyclic acid dianhydride may incorporate a tetravalent cyclobutane, cyclopentane, cyclohexane, cyclohexene, bicyclic alkane or a bicyclic alkene radical into the polymer component. Examples of suitable alicyclic acid dianhydrides that may be used in the present invention include, but are not limited to, 5-(2,5-dioxotetrahydrofuryl)-3-methylcyclohexene-1,2-dicarboxylic anhydride (DOCDA), bicyclooctene-2,3,5,6-tetracarboxylic dianhydride (BODA), 1,2,3,4-cyclobutanetetracarboxylic dianhydride (CBDA), 1,2,3,4-cyclopentanetetracarboxylic dianhydride (CPDA), 1,2,4,5-cyclohexanetetracarboxylic dianhydride (CHDA), 1,2,4-tricarboxy-3-methylcarboxylic dianhydride, and cyclopentane 1,2,3,4-tetracarboxylic dianhydride. In some embodiments, the alicyclic acid dianhydride may be present in an amount in a range of about 5 to about 90 mol %, and preferably in an amount in a range of about 10 to about 50 mol %, based on the total amount of the acid dianhydrides used.

In some embodiments of the present invention, the polymer component used in the present invention is highly soluble in common polar aprotic solvents, such as N-methyl-2-pyrrolidone (NMP), gamma-butyrolactone (GBL), dimethylformamide (DMF), dimethylacetamide (DMAc) and tetrahydrofuran (THF). With recent trends towards large-sized, high-resolution and high-quality liquid crystal displays, the printability of alignment agents is of particular importance. Under the circumstances, the superior solubility of a liquid crystal alignment agent according to some embodiments of the present invention positively impacts the printability of the alignment agent on substrates for the production of liquid crystal alignment films.

The synthesis of the polymer component is commonly carried out in an organic solvent in a range of about 0 to about 150° C., and preferably in a range of about 0 to about 100° C.

Any organic solvent that can dissolve the polymer component may be used without any particular limitation. Examples of suitable organic solvents include N-methyl-2-pyrrolidone, N,N-dimethylacetamide, N,N-dimethylformamide, dimethylsulfoxide, γ-butyrolactone, and phenolic solvents, such as m-cresol, phenol and halogenated phenols. These organic solvents may be used alone or in combination.

Non-solvents, which may include alcohols, ketones, esters, ethers, hydrocarbons and halogenated hydrocarbons, can be used in combination with the aforementioned organic solvents in appropriate ratios so long as the polymer component is not precipitated. Non-solvents may lower the surface energy of the alignment agent solution, contributing to an improvement in spreadability and flatness of the alignment agent solution on a substrate. In some embodiments of the present invention, the non-solvent is used in an amount in a range of about 1 to 80 parts by weight, and preferably in a range of about 5 to about 70 parts by weight with respect to the total weight of the solvents used. Specific examples of such non-solvents may include methanol, ethanol, isopropanol, cyclohexanol, ethylene glycol, propylene glycol, 1,4-butanediol, triethylene glycol, acetone, methyl ethyl ketone, cyclohexanone, methyl acetate, ethyl acetate, butyl acetate, diethyl oxalate, malonic acid ester diethyl ether, ethylene glycol monomethyl ether, ethylene glycol monoethyl ether, ethylene glycol phenyl ether, ethylene glycol phenyl methyl ether, ethylene glycol phenyl ethyl ether, ethylene glycol dimethylethyl, diethylene glycol dimethylethyl, diethylene glycol ether, diethylene glycol monomethyl ether, diethylene glycol monoethyl ether, diethylene glycol monomethyl ether acetate, diethylene glycol monoethyl ether acetate, ethylene glycol methyl ether acetate, ethylene glycol ethyl ether acetate, 4-hydroxy-4-methyl-2-pentanone, ethyl 2-hydroxy propionate, ethyl 2-hydroxy-2-methyl propionate, 2-butoxyethanol (butyl cellosolve), ethoxyethyl acetate, hydroxyethyl acetate, methyl 2-hydroxy-3-methyl butanoate, methyl 3-methoxy propionate, ethyl 3-methoxy propionate, ethyl 3-ethoxy propionate, methyl 3-ethoxy propionate, methyl methoxy butanol, ethyl methoxy butanol, methyl ethoxy butanol, ethyl ethoxy butanol, tetrahydrofuran, dichloromethane, 1,2-dichloroethane, 1,4-dichlorobutane, trichlorobenzene, o-dichlorobenzene, hexane, heptane, octane, benzene, toluene, and xylene.

In some embodiments of the present invention, the polymers in the polymer component may have a number average molecular weight in a range of about 10,000 to about 500,000 g/mol. In some embodiments, the polymers in the polymer component may have a glass transition temperature in a range of about 220 to about 350° C., depending on the imidization rate, when imidization proceeds, and the polymer structure.

Any suitable process for the imidization of the polyamic acids may be used. However, three processes for imidization of the polyamic acid are well known in the art. The first process is thermal imidization wherein a polyamic acid solution is applied to a substrate and thermally imidized in an oven or a hot plate at a temperature in a range of about 0 to about 250° C. However, substantial imidization may not occur below 100° C. Accordingly, in some methods, it is preferred to limit the imidization temperature to a range of about 150 to about 240° C. At this time, the imidization may proceed at a rate of about 40 to about 80%, depending on the kind of the polyamic acid.

The second process is chemical imidization wherein an imidization catalyst and a dehydrating agent are added to a polyamic acid solution to effect an imidization reaction at a temperature relatively lower than the temperature employed in the thermal imidization. In the chemical imidization, a tertiary amine, such as pyridine, lutidine or triethylamine, may be used as the imidization catalyst, and an acid anhydride, such as acetic anhydride, may be used as the dehydrating agent. Two moles of the dehydrating agent are reacted with one mole of the repeating unit of the polyamic acid to carry out imide ring-closure. Since the ring-closure rate varies depending on the temperature for the imidization, selection of appropriate temperature, catalyst and dehydrating agent may be important in preparing a polyimide of a desired imidization rate. The imidization is commonly carried out at a temperature in the range of about 30 to about 150° C. To prepare a polyimide having a high imidization rate, the catalyst and the dehydrating agent may be used in excessive amounts (3 moles or more) at a reaction temperature of less than 80° C., whereas they may be used in amounts of 3 moles or less at a reaction temperature of higher than 100° C.

The third process is a polycondensation between a tetracarboxylic dianhydride and a diisocyanate compound. Any aromatic or aliphatic diisocyanate compound can be used as the diisocyanate compound, as in diamines used in the polymerization of the polyamic acid. Specific examples of such diisocyanate compounds include p-phenylene diisocynate (PPDI) 1,6-hexamethylene diisocyanate (HDI), toluene diisocyanate (TDI), 1,5-naphthalene diisocyanate (NDI), isoporon diisocyanate (IPDI), 4,4-diphenylmethane diisocyanate (MDI), and cyclohexylmethane diisocyanate (H12MDI). These aromatic or aliphatic diisocyanate compounds may be used alone or in combination thereof as a mixture. The aromatic or aliphatic diisocyanate may be polycondensed with tetracarboxylic dianhydride to prepare a polyimide. At this time, the temperature for the polycondensation is commonly in a range of about 50 to about 200° C., and preferably in a range of about 90 to about 170° C.

In some embodiments of the present invention, the solids content of the polymer component and the epoxy compound of the liquid crystal alignment agent is in a range of about 0.01 to about 15% by weight, based on the total weight of the liquid crystal alignment agent.

A liquid crystal alignment agent according to some embodiments of the present invention may be applied to a substrate to produce a liquid crystal alignment film. Further, the liquid crystal alignment film can be used to fabricate a liquid crystal display.

Hereinafter, the present invention will be explained in more detail with reference to the following examples. However, these examples are given for the purpose of illustration and are not to be construed as limiting the scope of the invention.

### EXAMPLES

### Synthesis Example 1

### Preparation of 1-(3,5-diaminophenyl)-3-octadecyl-succinic imide

After 36.8 g (0.20 moles) of 3,5-dinitroaniline was dissolved in 200 mL of acetic acid in a 1-L reactor equipped with an agitator and a nitrogen injection system while nitrogen was slowly fed into the reactor, 70 g (0.20 moles) of 2-octadecen-1-yl succinic anhydride was added to the solution. The mixture was refluxed for 24 hours. The reaction solution was allowed to cool to room temperature to obtain a solid precipitate. The solid precipitate was recrystallized from methanol to yield 64.8 g (yield: 65%) of 1-(3,5-dinitrophenyl)-3-(1-octadecene)-succinic imide. 51.5 g (0.10 moles) of the product was dissolved in 500 ml of N-methyl pyrrolidone (NMP) and ethanol (1/3 (v/v)), and then the solution and 2.0 g of a Pd/C (5%) catalyst (which was prepared by applying palladium (5%) to the surface of carbon particles) were introduced into a hydrogenation reactor. The mixture was subjected to a reduction reaction at 50° C. for 2 hours. The reaction mixture was filtered and distilled under vacuum at 60° C. for 2 hours. The residue was recrystallized from a co-solvent of hexane/ethyl acetate, giving 27.0 g of 1-(3,5-diaminophenyl)-3-octadecyl-succinic imide.

### Synthesis Example 2

1.3523 g (0.0030 moles) of 1-(3,5-diaminophenyl)-3-octadecyl-succinic imide and 0.9585 g (0.005 moles) of paraphenylenediamine were charged into a 100-ml reactor equipped with an agitator and a nitrogen injection system, and then 1.11 g of NMP was added thereto. After the mixture was completely dissolved, 2.4489 g (0.0112 moles) of pyromellitic dianhydride (PMDA) was added to the solution. The mixture was allowed to react at room temperature for 2 hours. To the reaction mixture was added 79.3 g of NMP, giving 95.2 g of a polyamic acid (‘PAA-PMDA-1’) having a solids content of 5 wt %.

### Synthesis Example 3

After 1.6020 g (0.0035 moles) of 1-(3,5-diaminophenyl)-3-octadecyl-succinic imide prepared in Synthesis Example 1 and 1.1355 g (0.0105 moles) of paraphenylenediamine were charged into a 100-ml reactor equipped with an agitator and a nitrogen injection system, 12.8 g of NMP was added thereto. After the mixture was completely dissolved, 2.7455 g (0.0133 moles) of 1,2,3,4-cyclobutanetetracarboxylic dianhydride (CBDA) was added to the solution. The mixture was allowed to react at room temperature for 2 hours. To the reaction mixture was added 88.8 g of NMP, giving 106.91 g of a polyamic acid (‘PAA-CBDA-1’) having a solids content of 5 wt %.

### Synthesis Example 4

1.3003 g (0.0028 moles) of 1-(3,5-diaminophenyl)-3-octadecyl-succinic imide and 0.9216 g (0.0085 moles) of paraphenylenediamine were charged into a 100-ml reactor equipped with an agitator and a nitrogen injection system, and then 11.1 g of NMP was added thereto. After the mixture was completely dissolved, 2.5474 g (0.0114 moles) of 1,2,4-tricarboxy-3-methylcarboxy cyclopentane dianhydride (TCCP) was added to the solution. The mixture was allowed to react at room temperature for 8 hours. To the reaction mixture was added 79.5 g of NMP, giving 95.39 g of a polyamic acid solution (‘PAA-TCCP-1’) having a solids content of 5 wt %.

### Synthesis Example 5

1.1443 g (0.0025 moles) of 1-(3,5-diaminophenyl)-3-octadecyl-succinic imide and 1.4870 g (0.0075 moles) of 4,4-methylenedianiline (MDA) were charged into a 100-ml reactor equipped with an agitator and a nitrogen injection system, and then 11.4 g of NMP was added thereto. After the mixture was completely dissolved, 2.5474 g (0.0114 moles) of 1,2,4-tricarboxy-3-methylcarboxy cyclopentane dianhydride (TCCP) was added to the solution. The mixture was allowed to react at room temperature for 8 hours. To the reaction mixture was added 81.2 g of NMP, giving 97.46 g of a polyamic acid solution (‘PAA-TCCP-2’) having a solids content of 5 wt %.

### Synthesis Example 6

100 g of PAA-TCCP-1 (solids content: 5 wt %) prepared in Synthesis Example 4 was added to an excess of methanol to obtain a precipitate. The obtained precipitate was filtered, washed, and dried to obtain 4.5 g of a polymer solid. The polymer solid was charged into a 100-ml reactor equipped with an agitator and a nitrogen injection system, and then 40.5 g of NMP was added thereto. After the mixture was completely dissolved, the temperature was raised to 100° C. with stirring. 2.3 g of pyridine and 3.0 g of acetic anhydride were added to the mixture while maintaining the temperature at 100° C. The resulting mixture was subjected to imidization by dehydration ring closure for 5 hours. After completion of the reaction, an excess of methanol was added to the reaction mixture to obtain a precipitate. The obtained precipitate was filtered, washed, and dried to yield 4.5 g of a polymer solid. The polymer solid was dissolved in 76.0 g of NMP to give 80.0 g of a polyimide solution (‘PI-TCCP-1) having a solids content of 5 wt %.

### Synthesis Example 7

100 g of PAA-TCCP-2 (solids content: 5 wt %) prepared in Example 5 was added to an excess of methanol to obtain a precipitate. The obtained precipitate was filtered, washed, and dried to obtain 4.5 g of a polymer solid. The polymer solid was charged into a 100-ml reactor equipped with an agitator and a nitrogen injection system, and then 42.3 g of NMP was added thereto. After the mixture was completely dissolved, the temperature was raised to 100° C. with stirring. 2.4 g of pyridine and 3.1 g of acetic anhydride were added to the mixture while maintaining the temperature at 100° C. The resulting mixture was subjected to imidization by dehydration ring closure for 5 hours. After completion of the reaction, an excess of methanol was added to the reaction mixture to obtain a precipitate. The obtained precipitate was filtered, washed, and dried to yield 4.1 g of a polymer solid. The polymer solid was dissolved in 77.9 g of NMP to give 82.0 g of a polyimide solution (‘PI-TCCP-2) having a solids content of 5 wt %.

### Example 1

A solution of 0.25 g (10% relative to the total solids content) of an epoxy compound (TGDDM, Vantico) in 4.75 g of NMP was added to 50 g of the PAA-PMDA-1 solution (solids content: 5.0 wt %) prepared in Synthesis Example 2. The mixture was stirred for 12 hours and filtered through a filter (pore size: 0.1 μm) to prepare an alignment film solution (‘AL-PAA-PMDA-1’) having a solids content of 5.0 wt %. The alignment film solution thus prepared was applied to the ITO surface of an ITO glass substrate (size: 10 cm×10 cm), uniformly spin-coated to a thickness of 0.1 μm under specified conditions, and subjected to desolvation on a hot plate at 70° C. and curing at 210° C. to prepare a sample. The spreadability and curling properties of the sample were observed with naked eyes and under an optical microscope to evaluate the printability of the alignment film solution. The evaluation results are shown in Table 1 below.

To evaluate the liquid crystal alignment, chemical resistance, pretilt angle and electrooptical properties of the alignment film solution, a liquid crystal cell was manufactured in a different manner from the production of the sample. Specifically, the liquid crystal cell was manufactured in accordance with the following procedure. First, a pair of ITO glass substrates having a specified size were patterned by photolithography to leave a square ITO portion (size: 1.5 cm×1.5 cm) and an electrode ITO portion for voltage application intact on each of the ITO glass substrates and to remove portions other than the ITO portions. The alignment film solution was applied to the surface of the patterned ITO substrates, spin-coated to a thickness of 0.1 μm, and sequentially cured at 70° C. and 210° C. The two substrates were rubbed using a rubbing machine under given depth and speed conditions, arranged in such a manner that the rubbing directions of the substrates were opposite to each other (i.e. for VA mode/90°), and were adhered to each other so that the upper square ITO portion was exactly matched with the lower square ITO portion while maintaining the cell gap at 4.75 μm, completing the manufacture of the final liquid crystal cell. After a liquid crystal was filled into the cell, the alignment of the liquid crystal was observed under a cross-polarized optical microscope. The observation results are summarized in Table 1. A liquid crystal cell for the evaluation of the pretilt angle of the liquid crystal was separately manufactured in such a manner that the liquid crystal cell had a cell gap of 50 μm.

The liquid crystal cell having a cell gap of 50 μm was manufactured and the pretilt angle of the liquid crystal by each of the alignment film solution was measured by a crystal rotation method. The measurement results are shown in Table 1.

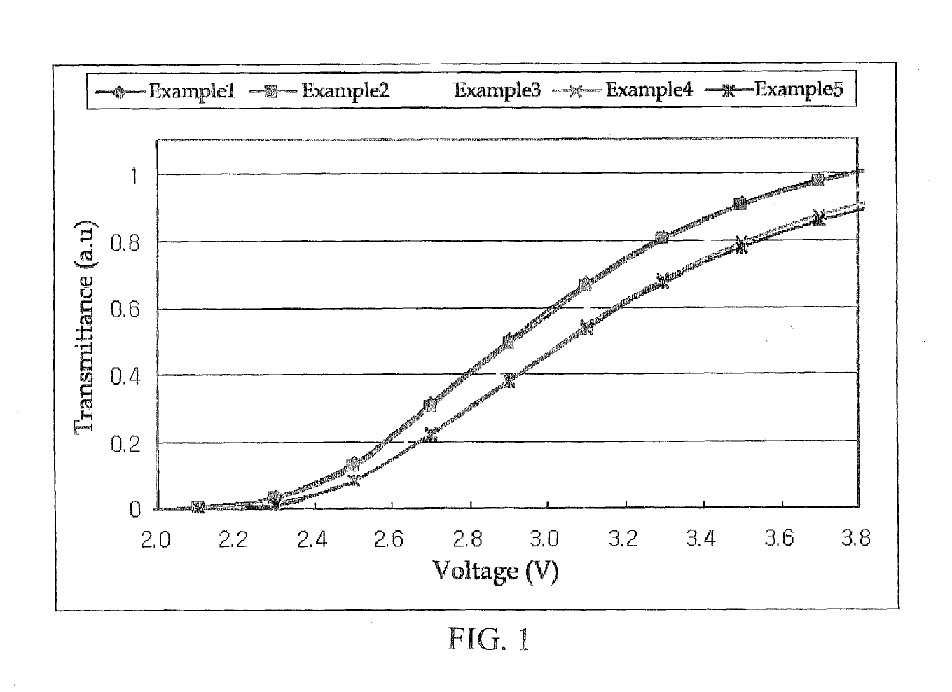

The electrooptical properties of the alignment film were measured using the liquid crystal cell having a cell gap of 4.75 μm. Specifically, the voltage-transmittance curve, voltage holding ratio, and residual DC voltage of the alignment film were measured and compared. Each of the electrooptical properties will be briefly explained below. The voltage-transmittance curve is one of key electrooptical properties determining the driving voltage of an LCD module. The voltage-transmittance curve is plotted by measuring the transmittance values of the liquid crystal cell while a voltage is applied to the liquid crystal cell, and normalizing the intensity of light in the brightest state (100%) and the intensity of light in the darkest state (0%). The voltage holding ratio refers to a ratio wherein a liquid crystal layer in a floating state with an external power supply maintains a charge voltage during a non-selective period in an active driving-type TFT-LCD. The closer the voltage holding ratio to 100%, the more ideal the alignment film becomes. The residual DC voltage refers to a voltage applied to a liquid crystal layer when ionized impurities present in the liquid crystal layer are adsorbed to the alignment film in the absence of an externally applied voltage. The lower the residual DC voltage, the better. The residual DC voltage is generally measured using a flicker or utilizing a curve showing changes in the electrical capacity of a liquid crystal layer according to the changes in DC voltage (C—V curve). The measured electrooptical properties of the alignment film using the liquid crystal cell are shown in Table 2 and FIG. 1.

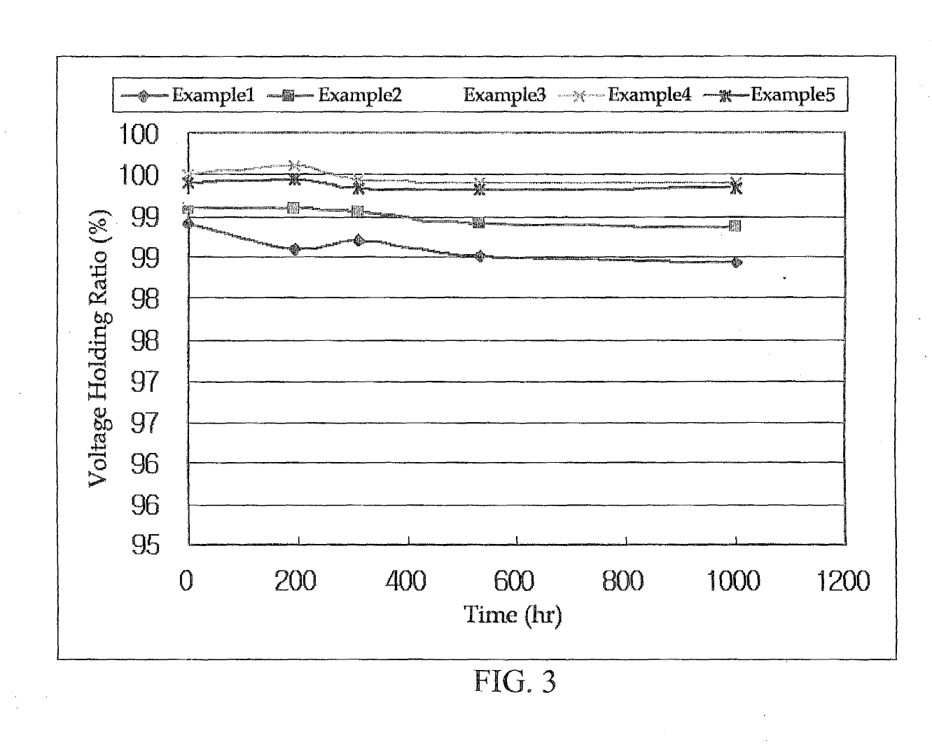

To evaluate the reliability of the alignment film after driving for a long period of time, a voltage was applied to the alignment film at a high temperature for 500 hours and then degree of reduction in voltage holding ratio was measured. The results are shown in FIG. 3.

### Example 2

A solution of 0.25 g (10% relative to the total solids content) of an epoxy compound (TGDDM) in 4.75 g of NMP was added to 50 g of the PAA-CBDA-1 solution (solids content: 5.0 wt %) prepared in Synthesis Example 3. The mixture was stirred for 12 hours and filtered through a filter (pore size: 0.1 μm) to prepare an alignment film solution (‘AL-PAA-CBDA-1’) having a solids content of 5.0 wt %. The printability, liquid crystal alignment, and pretilt angle of the alignment film solution were measured by the procedures described in Example 1, and the obtained results are shown in Table 1. The measurement results of electrooptical properties are summarized in Table 2, and the voltage-transmittance curve is plotted in FIG. 1. The degree of reduction in voltage holding ratio for the evaluation of reliability is shown in FIG. 3.

### Example 3

A solution of 0.25 g (10% relative to the total solids content) of an epoxy compound (TGDDM) in 4.75 g of NMP was added to 50 g of the PAA-TCCP-1 solution (solids content: 5.0 wt %) prepared in Synthesis Example 4. The mixture was stirred for 12 hours and filtered through a filter (pore size: 0.1 μm) to prepare an alignment film solution (‘AL-PAA-TCCP-1’) having a solids content of 5.0 wt %. The printability, liquid crystal alignment, and pretilt angle of the alignment film solution were measured by the procedures described in Example 1, and the obtained results are shown in Table 1. The measurement results of electrooptical properties are summarized in Table 2, and the voltage-transmittance curve is plotted in FIG. 1. The degree of reduction in voltage holding ratio for the evaluation of reliability is shown in FIG. 3.

### Example 4

A solution of 0.25 g (10% relative to the total solids content) of an epoxy compound (TGDDM) in 4.75 g of NMP was added to 50 g of the PI-TCCP-1 solution (solids content: 5.0 wt %) prepared in Synthesis Example 5. The mixture was stirred for 12 hours and filtered through a filter (pore size: 0.1 μm) to prepare an alignment film solution (‘AL-PI-TCCP-1’) having a solids content of 5.0 wt %. The printability, liquid crystal alignment, and pretilt angle of the alignment film solution were measured by the procedures described in Example 1, and the obtained results are shown in Table 1. The measurement results of electrooptical properties are summarized in Table 2, and the voltage-transmittance curve is plotted in FIG. 1. The degree of reduction in voltage holding ratio for the evaluation of reliability is shown in FIG. 3.

### Example 5

A solution of 0.25 g (10% relative to the total solids content) of an epoxy compound (TGDDM) in 4.75 g of NMP was added to 50 g of the PI-TCCP-2 solution (solids content: 5.0 wt %) prepared in Synthesis Example 6. The mixture was stirred for 12 hours and filtered through a filter (pore size: 0.1 μm) to prepare an alignment film solution (‘AL-PI-TCCP-2’) having a solids content of 5.0 wt %. The printability, liquid crystal alignment, and pretilt angle of the alignment film solution were measured by the procedures described in Example 1, and the obtained results are shown in Table 1. The measurement results of electrooptical properties are summarized in Table 2, and the voltage-transmittance curve is plotted in FIG. 1. The degree of reduction in voltage holding ratio for the evaluation of reliability is shown in FIG. 3.

### Comparative Example 1

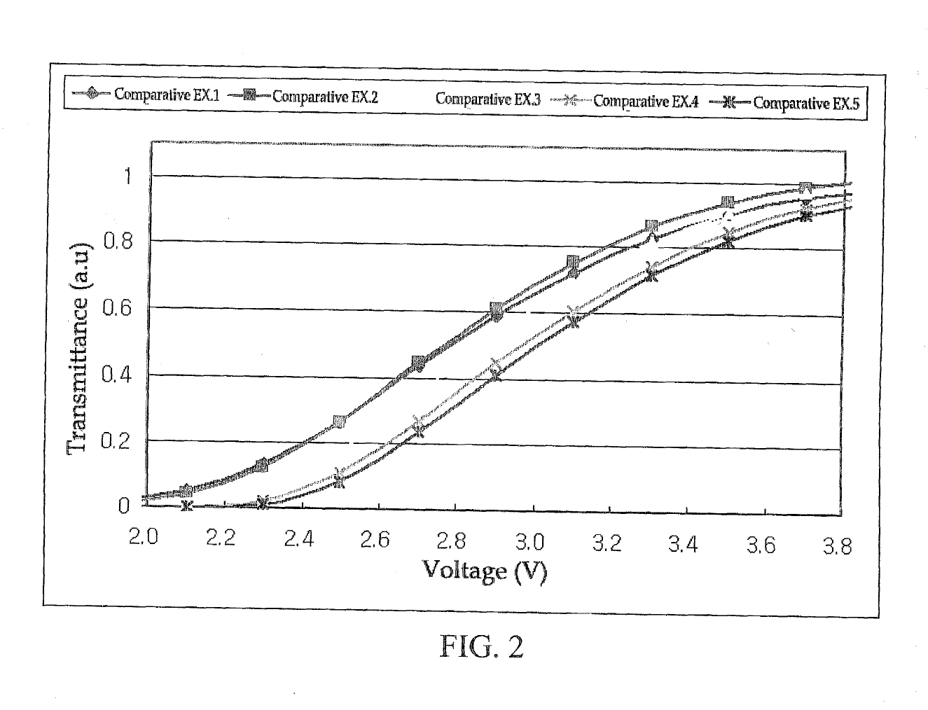

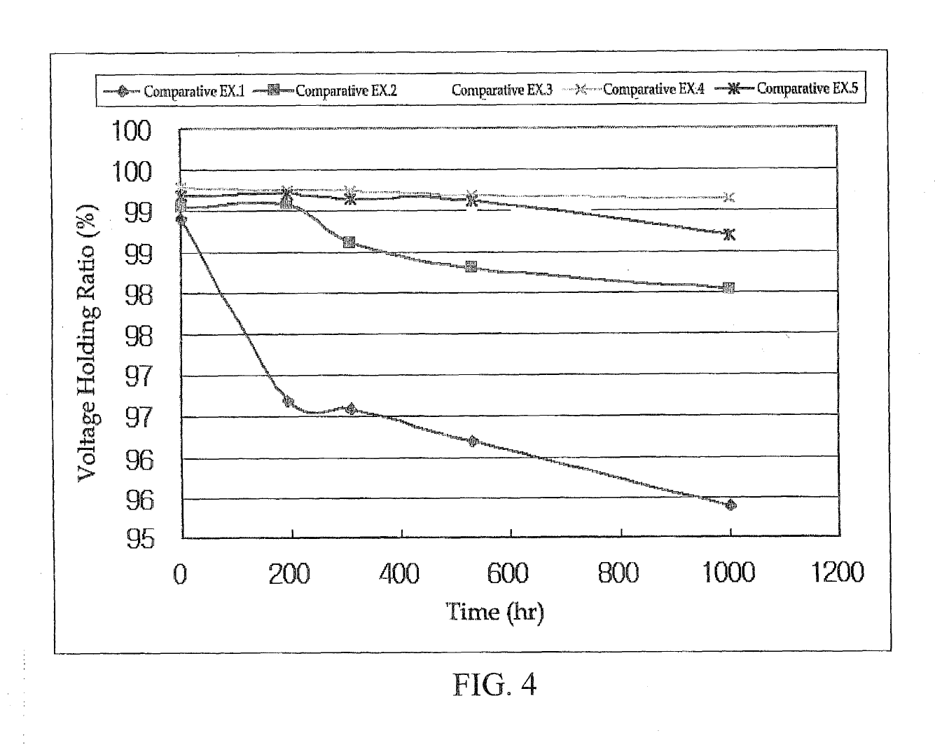

An alignment film solution (‘R-PAA-PMDA-1’) was prepared in the same maimer as in Example 1, except that no epoxy compound was added. The printability, liquid crystal alignment, and pretilt angle of the alignment film solution were measured by the procedures described in Example 1, and the obtained results are shown in Table 1. The measurement results of electrooptical properties are summarized in Table 2, and the voltage-transmittance curve is plotted in FIG. 2. The degree of reduction in voltage holding ratio for the evaluation of reliability is shown in FIG. 4.

### Comparative Example 2

An alignment film solution (‘R-PAA-CBDA-1’) was prepared in the same manner as in Example 2, except that no epoxy compound was added. The printability, liquid crystal alignment, and pretilt angle of the alignment film solution were measured by the procedures described in Example 1, and the obtained results are shown in Table 1. The measurement results of electrooptical properties are summarized in Table 2, and the voltage-transmittance curve is plotted in FIG. 2. The degree of reduction in voltage holding ratio for the evaluation of reliability is shown in FIG. 4.

### Comparative Example 3

An alignment film solution (‘R-PAA-TCCP-1’) was prepared in the same manner as in Example 3, except that no epoxy compound was added. The printability, liquid crystal alignment, and pretilt angle of the alignment film solution were measured by the procedures described in Example 1, and the obtained results are shown in Table 1. The measurement results of electrooptical properties are summarized in Table 2, and the voltage-transmittance curve is plotted in FIG. 2. The degree of reduction in voltage holding ratio for the evaluation of reliability is shown in FIG. 4.

### Comparative Example 4

An alignment film solution (‘R-PI-TCCP-1’) was prepared in the same manner as in Example 4, except that no epoxy compound was added. The printability, liquid crystal alignment, and pretilt angle of the alignment film solution were measured by the procedures described in Example 1, and the obtained results are shown in Table 1. The measurement results of electrooptical properties are summarized in Table 2, and the voltage-transmittance curve is plotted in FIG. 2. The degree of reduction in voltage holding ratio for the evaluation of reliability is shown in FIG. 4.

### Comparative Example 5

An alignment film solution (‘R-PI-TCCP-2’) was prepared in the same maimer as in Example 5, except that no epoxy compound was added. The printability, liquid crystal alignment, and pretilt angle of the alignment film solution were measured by the procedures described in Example 1, and the obtained results are shown in Table 1. The measurement results of electrooptical properties are summarized in Table 2, and the voltage-transmittance curve is plotted in FIG. 2. The degree of reduction in voltage holding ratio for the evaluation of reliability is shown in FIG. 4.

TABLE 1

| | | Vertical | Alignment | |
|---|---|---|---|---|
| Sample | Printability | alignment | uniformity | Pretilt angle (°) |
| Example 1 | Good | Good | Good | 89.3 |
| Example 2 | Good | Good | Good | 89.4 |
| Example 3 | Good | Good | Good | 89.5 |
| Example 4 | Good | Good | Good | 89.7 |
| Example 5 | Good | Good | Good | 89.8 |
| Comparative | Good | Good | Good | 88.4 |
| Example 1 | | | | |
| Comparative | Good | Good | Good | 88.4 |
| Example 2 | | | | |
| Comparative | Good | Good | Good | 88.6 |
| Example 3 | | | | |
| Comparative | Good | Good | Good | 89.1 |
| Example 4 | | | | |
| Comparative | Good | Good | Good | 89.2 |
| Example 5 | | | | |

TABLE 2

| | Voltage holding ratio (%) | | Residual DC voltage (by |
|---|---|---|---|
| Sample | Room temp. | High temp. | C-V curve) |
| Example 1 | 99.0 | 98.9 | 170 |
| Example 2 | 99.3 | 99.1 | 160 |
| Example 3 | 99.4 | 99.2 | 140 |
| Example 4 | 99.7 | 99.5 | 110 |
| Example 5 | 99.6 | 99.4 | 110 |
| Comparative | 98.9 | 98.9 | 260 |
| Example 1 | | | |
| Comparative | 99.2 | 99.1 | 240 |
| Example 2 | | | |
| Comparative | 99.3 | 99.2 | 210 |
| Example 3 | | | |
| Comparative | 99.4 | 99.3 | 180 |
| Example 4 | | | |
| Comparative | 99.3 | 99.2 | 190 |
| Example 5 | | | |

As apparent from the above description, the liquid crystal alignment agent of the present invention shows superior liquid crystal alignment and vertical alignment, low residual DC voltage, low reduction in voltage holding ratio even after driving for a long period of time, and high reliability.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A liquid crystal alignment agent comprising
a polymer component comprising a polyamic acid repeating unit of Formula 1 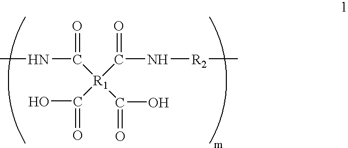
wherein
R₁ is a tetravalent organic radical; and
R₂ comprises the bivalent radical of Formula 2 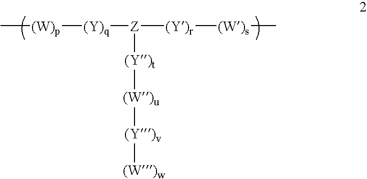
wherein
W, W′ and W″ are each independently a bivalent aromatic, heteroaromatic, alicylic or heterocyclic radical, wherein the bivalent aromatic, heteroaromatic, alicyclic or heterocyclic radical is optionally substituted with an alkyl and/or a halogen group;
Y, Y′ , Y″ and Y′″ are each independently selected from the group consisting of oxy, oxyacyl, acyloxy, acylamino, aminoacyl and alkylene;
Z is a trivalent radical selected from the group consisting of a trivalent aromatic, heteroaromatic, alicyclic and heterocyclic radical, wherein the trivalent radical is optionally substituted with an alkyl group;
W′″ is selected from the group consisting of an aromatic, heteroaromatic, alicylic and heterocyclic radical, wherein the aromatic, heteroaromatic, alicylic and heterocyclic radical is optionally substituted with one or more linear, branched or cyclic alkyl radicals, and wherein the linear, branched or cyclic alkyl radicals are optionally substituted with 1-10 halogen atoms, optionally comprise one or more sites of unsaturation and optionally comprise one or more of an ether, ester or amide linkage;
wherein m is a positive integer;
wherein p, q, r, s, t, u, v and w are each independently either 0 or 1, with the proviso that at least one of u and w is 1; and
wherein one or more of the amic acids in one or more of the repeating units of Formula 1 is optionally cyclized to forth an imide.

2. The liquid crystal alignment agent of claim 1, wherein R₁ is a tetravalent alicyclic radical selected from the group consisting of a tetravalent cyclobutane radical, a tetravalent cyclopentane radical, a tetravalent cyclohexane radical, a tetravalent cyclohexene radical, a tetravalent bicyclic alkane radical and a tetravalent bicyclic alkene radical, wherein the tetravalent alicyclic radical is optionally substituted with one or more alkyl and/or fluoro groups; or a tetravalent aromatic radical selected from the group consisting of Formula 3 and Formula 4 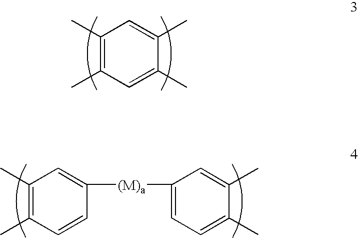
wherein M is selected from the group consisting of oxy, carbonyl, alkylene, and fluoralkylene; and a is 0 or 1.

3. The liquid crystal alignment agent of claim 2, wherein R₁ is a tetravalent radical selected from the group consisting of: 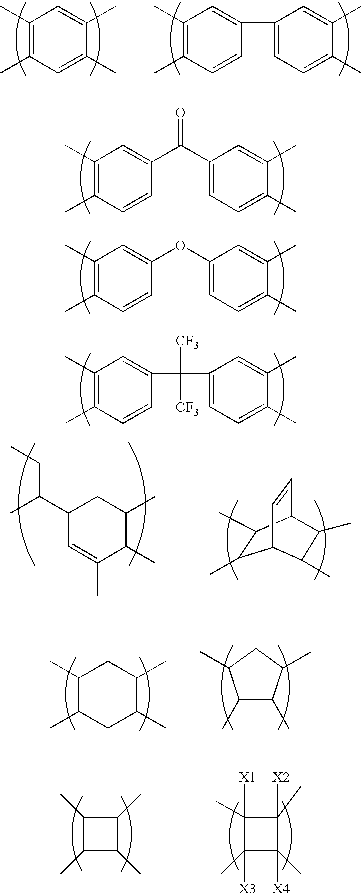
wherein X₁-X₄ are each independently methyl, F or H.

4. The liquid crystal alignment agent of claim 1, wherein R₂ comprises the bivalent radical of Formula 5 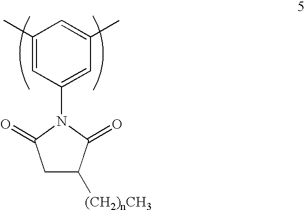
wherein n is a positive integer in a range of about 1 to about 30.

5. The liquid crystal alignment agent of claim 1, wherein R₂ comprises the bivalent radical of Formula 6 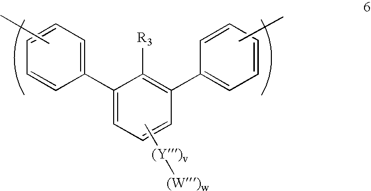
wherein
Y′″ is selected from the group consisting of oxy, acyloxy, oxyacyl, acylamino, and C₁-C₁₀ alkylene;
W′″ is a C₃-C₂₀ cyclic alkyl radical, wherein the cyclic alkyl radical is optionally substituted with 1-10 halogen atoms and optionally comprises one or more of an ether, ester or amide linkage; C₆-C₃₀ aryl radical, wherein the aryl radical is optionally substituted with 1-10 halogen atoms and is optionally substituted with one or more linear, branched or cyclic alkyl radicals, wherein the linear, branched or cyclic alkyl radicals are optionally substituted with 1-10 halogen atoms and optionally comprise one or more of an amino, ester or amide linkage; and a C₆-C₃₀ heteroaryl radical;
R₃ is hydrogen or a methyl group; and
v and w are 1.

6. The liquid crystal alignment agent of claim 1, wherein R₂ comprises the bivalent radical of Formula 7 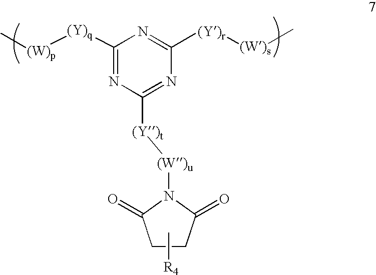
wherein
W and W′ are each independently phenylene, alkyl-substituted phenylene or an alicyclic ring;
Y, Y′ and Y″ are each independently selected from the group consisting of oxy, acyloxy, oxyacyl and acylamino;
W″ is selected from the group consisting of phenylene and an alicyclic ring; and
R₄ is a saturated or unsaturated C₁-C₂₀ linear, branched or alicyclic alkyl group, wherein the alkyl group is optionally substituted with at least one halogen atom.

7. The liquid crystal alignment agent of claim 1, wherein R₂ comprises the bivalent radical of Formula 8 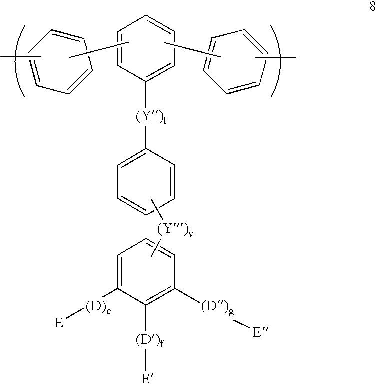
wherein
Y″ and Y′″ are each independently selected from the group consisting of oxy, acyloxy, oxyacyl, and acylamino;
D, D′ and D″ are each independently is selected from the group consisting of oxy, acyloxy, oxyacyl, and acylamino and e, f and g are each independently 0 or 1; and
E, E′ and E″ are each independently a C₁-C₂₀ linear, branched or cyclic alkyl group, optionally substituted with one or more halogen atoms.

8. The liquid crystal alignment agent of claim 1, wherein R₂ further comprises one or more of a bivalent aromatic radical and a siloxane of Formula 9:

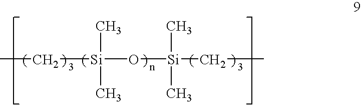

9. The liquid crystal alignment agent of claim 8, wherein the bivalent aromatic group comprises one or more of the bivalent radicals of Formulae 10-12 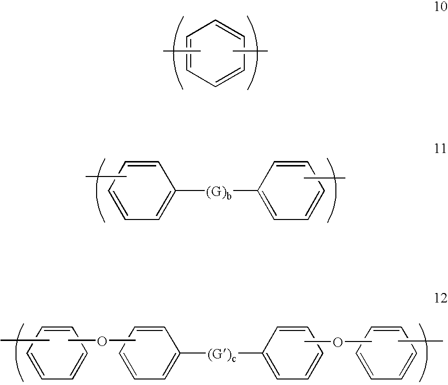
wherein G and G′ are each independently selected from the group consisting of oxy, sulfonyl, linear or branched alkylene and linear or branched fluoroalkylene, and b and c are each independently 0 or 1.

10. The liquid crystal alignment agent of claim 9, wherein G and G′ are selected from the group consisting of sulfonyl, methylene, oxy, bis(triflouromethyl)methylene and propane-2,2-diyl, wherein b and c are 1.

11. The liquid crystal alignment agent of claim 8, wherein the bivalent radical of Formula 2 is present in an amount in a range of 0.1-50%, based on the total amount of R₂ bivalent radicals.

12. The liquid crystal alignment agent of claim 1, further comprising an epoxy compound and an organic solvent.

13. The liquid crystal alignment agent of claim 12, wherein the epoxy compound has the chemical structure of Formula 13: 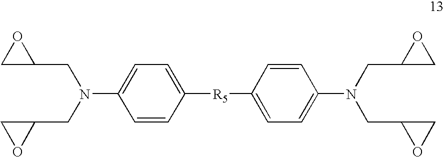
wherein R₅ is a bivalent aromatic radical or a C₁-C₄ bivalent alicyclic radical.

14. The liquid crystal alignment agent of claim 12, wherein the polymer and the epoxy compound together are present in an amount in a range of 0.01 to 15 parts by weight, based on 100 parts of the liquid crystal alignment agent.

15. The liquid crystal alignment agent of claim 12, wherein the epoxy compound is present in an amount in a range of 0.01 to 50 parts by weight of the epoxy compound, based on 100 parts by weight of the polymer component.

16. A liquid crystal alignment film produced by applying the liquid crystal alignment agent of claim 1 to a substrate.

17. A liquid crystal display comprising the liquid crystal alignment film of claim 16.

18. A liquid crystal alignment agent comprising a polymer component comprising a polyamic acid repeating unit of Formula 1 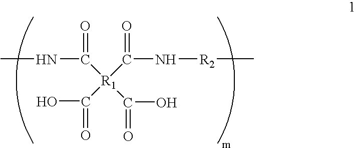
wherein
R₁ is a tetravalent organic radical; and
R₂ comprises the bivalent radical of Formula 6 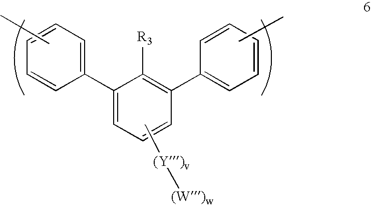
wherein
Y′″ is selected from the group consisting of oxy, acyloxy, oxyacyl, acylamino, and alkylene;
W′″ is a C₁-C₂₀ linear or branched alkyl radical, wherein the linear or branched alkyl radical is optionally substituted with 1-10 halogen atoms and optionally comprises one or more of an ether, ester or amide linkage;
R₃ is hydrogen or a methyl group;
v and w are 1; and
wherein one or more of the amic acids in one or more of the repeating units of Formula 1 is optionally cyclized to form an imide.

19. The liquid crystal alignment agent of claim 18, further comprising an epoxy compound and an organic solvent.

20. The liquid crystal alignment agent of claim 19, wherein the epoxy compound has the chemical structure of Formula 13: 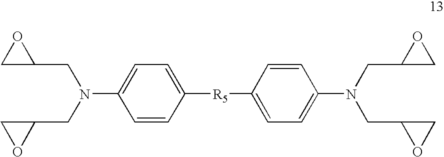
wherein R₅ is a bivalent aromatic radical or a C₁-C₄ bivalent alicyclic radical.
